(19) United States
(12) Patent Application Publication
(10) Pub. No.: US 2026/0035302 A1
(43) Pub. Date: Feb. 5, 2026

(54) Concrete Composition with Corrosion Inhibitor

(71) Applicants: Donald P. Visco, JR., Canton, OH (US); Ahmed Mohamed, Stow, OH (US); David M. Bastidas, Fairlawn, OH (US); Anil Patnaik, Kent, OH (US)

(72) Inventors: Donald P. Visco, JR., Canton, OH (US); Ahmed Mohamed, Stow, OH (US); David M. Bastidas, Fairlawn, OH (US); Anil Patnaik, Kent, OH (US)

(21) Appl. No.: 19/287,652

(22) Filed: Jul. 31, 2025

Related U.S. Application Data
(60) Provisional application No. 63/677,547, filed on Jul. 31, 2024.

(51) Int. Cl. C04B 28/04; C04B 14/34; C04B 24/04; C04B 24/12; C04B 103/61

(52) U.S. Cl. CPC C04B 28/04; C04B 14/34; C04B 24/045; C04B 24/128; C04B 2103/61

(57) ABSTRACT

A concrete composition includes binder, aggregate, and a corrosion inhibitor. The chemical compound of the corrosion inhibitor includes an alkoxy group, a carboxyl group, and a nitrogen-containing aromatic group. An example of the corrosion inhibitor is methyl nicotinate. Where the concrete composition is reinforced with reinforcing bars, such as carbon steel, the corrosion inhibitor can inhibit corrosion of the reinforcing bars.

### CROSS REFERENCE TO RELATED APPLICATIONS

This application claims the benefit of U.S. provisional patent application Ser. No. 63/677,547, filed Jul. 31, 2024, which is incorporated by reference herein.

### FIELD OF THE INVENTION

One or more embodiments of the invention are directed toward a concrete composition with a corrosion inhibitor.

### BACKGROUND

Corrosion damage is common in steel reinforced concrete structures particularly in marine environments. Corrosion-induced cracks and spalling lead to a loss of bond strength, which in turn causes reduction in structural strength. The surface condition of the embedded steel rebars greatly impacts the performance of steel reinforced concrete. The service life of a steel reinforced concrete structure is reduced when corrosion-induced cracking and spalling occur. Using a corrosion inhibitor in concrete is an effective method to reduce the possibility of corrosion of steel reinforcing bars within concrete.

Conventional corrosion inhibitors for concrete include nitrites, nitrates, phosphates, and amines/alkanolamines. However, at least some of these conventional corrosion inhibitors can be expensive and heavily regulated, particularly due to negative environmental impacts. As such, there remains a need for improved corrosion inhibition for concrete compositions.

### SUMMARY

An aspect of the present invention provides a concrete composition with a corrosion inhibitor. The corrosion inhibitor can include an alkoxy group, a carboxyl group, and a nitrogen-containing aromatic group. The corrosion inhibitor can be methyl nicotinate. The concrete composition can be reinforced with reinforcing bars.

### BRIEF DESCRIPTION OF THE DRAWINGS

Advantages of the present invention will become better understood with regard to the following description, appended claims, and accompanying drawings wherein:

FIG. 1 is a schematic of a reinforced concrete composition including a corrosion inhibitor;

FIG. 2 is a graph showing slump test results for various concrete compositions;

FIG. 3 is a graph showing air content results for various concrete compositions;

FIG. 4 is a graph showing compressive strength results for various concrete compositions;

FIG. 5 is a photograph showing corrosion results for first sides of various reinforcing bars utilized with various concrete compositions; and

FIG. 6 is a photograph showing corrosion results for second sides of various reinforcing bars utilized with various concrete compositions.

### DETAILED DESCRIPTION

Embodiments of the invention are based on a concrete composition with a corrosion inhibitor. The corrosion inhibitor can include an alkoxy group, a carboxyl group, and a nitrogen-containing aromatic group. The corrosion inhibitor can be methyl nicotinate, which is a methyl ester of niacin. The concrete composition can be reinforced with reinforcing bars, which may be referred to as rebars or reinforcement bars. Advantageously, the corrosion inhibitor is environmentally friendly, non-toxic, available, affordable, and effective. The corrosion inhibitor, such as methyl nicotinate, offers significant advantages as a corrosion inhibitor for rebars, such as carbon steel rebars, in reinforced concrete when compared to existing alternatives. Methyl nicotinate (“MN”) has relatively high solubility in high pH environments, making it a compatible compound for mixing in wet concrete which has high pH during the hydration process.

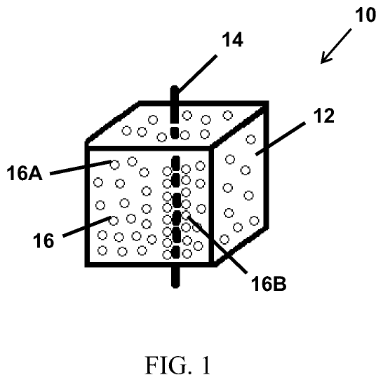

With particular reference to FIG. 1, one or more embodiments of the present invention provide a concrete assembly which is generally shown with the numeral 10. Concrete assembly 10 includes a concrete composition 12 which can include one or more reinforcing bars 14, which may be referred to as rebars 14. Concrete composition 12 includes corrosion inhibitor 16, which can include bulk corrosion inhibitor 16A within the concrete composition 12 not nearby rebars 14 and/or rebar corrosion inhibitor 16B which is nearby rebars 14, which may be referred to as protective layer 16B. The corrosion inhibitor 16B may or may not be coated on the rebar 14 prior to inclusion with the concrete composition 12.

Where the concrete composition 12 includes rebars 14, the concrete assembly 10 may be referred to as reinforced concrete 10. The properties of rebars 14 will be generally known to the skilled person though certain details are provided herein. Rebars 14 can be made of carbon steel, though other steel materials and composite materials may be suitable. Rebars 14 may be uncoated or coated, such as with zinc or epoxy resin.

The skilled person will generally understand details for adapting and developing the concrete composition 12, which may be referred to as cementitious material 12, in which the corrosion inhibitor 16 is employed, though certain details are provided herein. Concrete composition 12 generally includes a binder (e.g., cement), aggregate, water, and optionally other desirable additives as generally known to the skilled person. The water to cement ratio is one consideration for developing suitable concrete compositions and suitable ratios can be developed by the skilled person. Corrosion inhibitor 16 is an exemplary additive. In one or more embodiments, corrosion inhibitor 16 can be mixed with the water as a solution prior to being mixed with other concrete ingredients, such as the dry ingredients. In other embodiments, corrosion inhibitor 16 can be added directly to a concrete composition separate from the water or another component. The corrosion inhibitor 16 can be added before or after a step of mixing the concrete composition. In one or more embodiments, the corrosion inhibitor 16 can be added in conjunction with a polymer medium additive. Exemplary polymer additives are generally known to the skilled person and include polyester-styrene, epoxy-styrene, furans, vinylidene chloride, and others.

Other exemplary additives include those which enhance the rheological properties and/or the speed of the curing process. Another exemplary additive is high range water reducers, such as polycarboxylate water reducers. One such polycarboxylate water reducer is available from Euclid Chemicals under the trade name Plastol 6400. Further exemplary additives are those added to increase compressive strength, such as alkanolamine materials.

Reference to the term concrete composition can be to either a composition which will become a final concrete material or to the final concrete material itself. As generally known, an initial, wet composition will become a final, dry, hardened concrete composition. Structural concrete can be particularly made by mixing dry ingredients in a concrete mixer and adding the appropriate amount of water, which can include the corrosion inhibitor disclosed herein, while mixing the ingredients. Hydration of cement, a chemical process between cement and water, occurs when the cement comes in contact with water.

After sufficient mixing to form a wet concrete composition, which may be referred to as fresh concrete, including the corrosion inhibitor 16, the wet concrete composition can then be poured into a desired mold or formwork. The molds or formwork are adapted to achieve the desired size and shape of concrete structural elements. The mold or formwork would include the reinforcing bars 14, where desired. The skilled artisan will appreciate that the reinforcing bars 14, such as carbon steel bars, will often be configured in a lattice structure (not depicted in FIG. 1) that provides the cured concrete structure with added strength and support. With time, the chemical reactions take place, and the wet concrete gets hardened to form structural concrete. Upon curing of the wet concrete composition, the corrosion inhibitor 16 becomes an integral part of the concrete matrix, which can include forming protective layer 16B on the embedded reinforcing bars 14.

For the concrete composition, the aggregates can be inert granular materials such as sand, gravel, stones, shells, and recycled concrete. The aggregates can include fine aggregate and/or coarse aggregate. The particle shape and surface texture can be considered relative to the properties of the mixed concrete, as well as considering the desired properties of the hardened concrete. In some embodiments, the aggregates can make up from about 60% to about 75% of the volume of concrete.

In some embodiments, Portland cement can be utilized as a binder, which may also be referred to as a binding material. Other exemplary binding materials include lime, hydraulic lime, natural cement, and those generally known as supplementary cementitious materials (SCM). Exemplary supplementary cementitious materials include industrial waste products, such as granulated blast furnace slag, fly ash, and silica fume.

As mentioned above, the corrosion inhibitor employed in the cement composition is advantageously environmentally friendly and non-toxic. The non-toxicity can be defined as having noticeable effect on humans when handling standard quantities, though other definitions may be utilized. The corrosion inhibitor should have suitable solubility in water. The corrosion inhibitor should be capable of surviving the harsh conditions to which the cement composition might be subjected, particularly during formation of cement composition. Conditions during cement hydration can include relatively high pH, such as up to about pH 13, and relatively high temperatures, such as up to about from 50° C. to 60° C.

In one or more embodiments, the chemical compound of the corrosion inhibitor includes a methoxy group, a carboxyl group, and nitrogen-containing aromatic. In one or more embodiments, the carboxyl group connects the alkoxy group and the nitrogen-containing aromatic group. Exemplary alkoxy groups include a methoxy group or an ethoxy group. Exemplary nitrogen-containing aromatic groups include a pyridine group or a pyrrole group. In one or more embodiments, the corrosion inhibitor is a methyl ester. In one or more embodiments, the corrosion inhibitor is methyl nicotinate. The corrosion inhibitor, such as methyl nicotinate, can be provided in solid crystal form.

The concrete composition which includes the corrosion inhibitor can be characterized relative to the amount of corrosion inhibitor therein.

In one or more embodiments, a concrete composition includes from about 1 ounce of corrosion inhibitor per 100 pounds of binder (e.g., cement) (oz/cwt) to 80 oz/cwt, or from about 3 oz/cwt to 5 oz/cwt, or from about 1 oz/cwt to 10 oz/cwt, or from about 5 oz/cwt to 10 oz/cwt, or from about 10 oz/cwt to 20 oz/cwt, or from about 15 oz/cwt to 25 oz/cwt, or from about 30 oz/cwt to 50 oz/cwt, or from about 30 oz/cwt to 70 oz/cwt, or from about 50 oz/cwt to 70 oz/cwt, of corrosion inhibitor (e.g., methyl nicotinate) per cement. In these or other embodiments, a concrete composition includes at least 5 oz/cwt, or at least 10 oz/cwt, or at least 15 oz/cwt, or at least 20 oz/cwt, or at least 30 oz/cwt, or at least 50 oz/cwt, or at least 70 oz/cwt of corrosion inhibitor (e.g., methyl nicotinate) per cement. In these or other embodiments, a concrete composition includes less than 80 oz/cwt, or less than 60 oz/cwt, or less than 40 oz/cwt, or less than 20 oz/cwt, or less than 15 oz/cwt, or less than 10 oz/cwt, or less than 5 oz/cwt, or less than 3 oz/cwt of corrosion inhibitor (e.g., methyl nicotinate) per cement. In these or other embodiments, a concrete composition includes about 3 oz/cwt, or about 5 oz/cwt, or about 10 oz/cwt, or about 15 oz/cwt, or about 20 oz/cwt, or about 30 oz/cwt, or about 50 oz/cwt, or about 70 oz/cwt of corrosion inhibitor (e.g., methyl nicotinate) per cement.

In one or more embodiments, a concrete composition includes from about 1 lb. of corrosion inhibitor per cubic yard of concrete to 25 lbs/yd³, or from about 1 lbs/yd³ to 5 lbs/yd³, or from about 5 lbs/yd³ to 10 lbs/yd³, or from about 5 lbs/yd³ to 20 lbs/yd³, or from about 10 lbs/yd³ to 15 lbs/yd³, or from about 15 lbs/yd³ to 25 lbs/yd³, of corrosion inhibitor per concrete. In one or more embodiments, a concrete composition includes about 1 lb/yd³, or about 5 lbs/yd³, or about 10 lbs/yd³, or about 15 lbs/yd³, or about 20 lbs/yd³, or about 25 lbs/yd³, of corrosion inhibitor per concrete.

Where the corrosion inhibitor is mixed in solution with water, the molecular weight of the corrosion inhibitor might be considered as lower molecular weights can indicate greater solubility in water. If the corrosion inhibitor has a relatively high solubility, it might be applied with a concrete composition at a higher concentration while maintaining even dispersion. In one or more embodiments, the molecular weight of the corrosion inhibitor is less than 150 g/mol, or less than 145 g/mol, or less than 140 g/mol. In one or more embodiments, the molecular weight of the corrosion inhibitor is between 115 and 150 g/mol, or between 120 and 145 g/mol, or between 125 and 140 g/mol.

The energy gap (E_{gap}) of a corrosion inhibitor can also be considered. The skilled artisan will appreciate that energy gap is a function of the energy of the highest occupied molecular orbital and the energy of the lowest unoccupied molecular orbital. If the energy gap is too large, the corrosion inhibitor will not easily exchange electrons with the steel reinforcing bars, resulting in a weaker bond with the steel surface. If it is too small, the corrosion inhibitor might be too reactive which could render the corrosion inhibitor ineffective. energy gap. In one or more embodiments, the energy gap value of the corrosion inhibitor is less than 6.5 eV, or less than 6.0 eV, or less than 5.5 eV. In one or more embodiments, the energy gap value of the corrosion inhibitor is more than 3.5 eV, or more than 4.0 eV, or more than 4.5 eV. In one or more embodiments, the energy gap value of the corrosion inhibitor is between 3.5 eV and 6.5 eV, or between 4.0 eV and 6.0 eV, or between 4.5 eV and 5.5 eV.

In light of the foregoing, it should be appreciated that the present invention advances the art by providing improvements for a concrete composition with a corrosion inhibitor. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### Examples

In the following examples, details of testing regarding the effectiveness of methyl nicotinate (“MN”) as a corrosion inhibitor are outlined.

### Approach

Wet concrete and hardened concrete properties were determined for concrete mixed with MN. Corrosion performance of steel reinforcing bars embedded in concrete was determined using accelerated corrosion tests. Concrete mixes with several variable mix proportions were made. Uncoated steel reinforcing bars were embedded in concrete cubes to perform corrosion tests with pull-out tests before and after corrosion. The corrosion effects on the embedded rebar was tested at different dosages of MN. The bond strength of rebars was evaluated by conducting pull-out tests after subjecting the specimens to accelerated corrosion.

### Materials Used for Testing

Typical uncoated #5 steel reinforcing bars were used. The surface of each rebar was cleaned to remove initial rust.

Type 1L Portland Cement was used as a cementitious material. River sand was used in the tests as the fine aggregate and #57 aggregate as the coarse aggregate. The mix proportions for the concrete are shown in Table 1.

TABLE 1
Concrete Mix Proportions

| Ingredient | lb/yd³ | lb/ft³ |
|---|---|---|
| Cement | 564 | 21 |
| Fine Aggregate (Sand) | 1,405 | 53 |
| Coarse Aggregate | 1,800 | 67 |
| Water | 293 | 11 |

The material available from Euclid Chemicals as Plastol 6400 was used as a high range water reducer (HRWR). It was added to the concrete mix to achieve adequate workability and to reduce the water demand. All the mixes were non-air-entrained mixes.

### Test Methodology

The use of MN as a corrosion inhibitor in concrete was evaluated in two phases. In Phase I, a sealing method was used to protect the protruding end of the rebar, which was proved to be ineffective. The silicone sealant that was used to seal the ends allowed water to seep through and accumulate at the end cap of each specimen, leading to unintended corrosion concentration at the exposed end of the rebar rather than developing along the embedded length in a distributed manner. As a result, the embedded length of the rebar remained largely unaffected by the corrosion process, making it difficult to properly evaluate the effect of MN addition on pull-out strength or corrosion inhibition. However, the wet concrete properties and the compressive strength evaluation were more conclusive. Therefore, Phase II tests were conducted with improved sealing techniques to ensure that the corrosion of the embedded length of the rebar was confined to the length exposed to concrete rather than at the protruding ends of the rebar.

For corrosion tests, 20 cube specimens were made in Phase I from five batches of concrete. Half of those specimens were subjected to targeted accelerated corrosion exposure using induced current. Similarly for Phase II, 16 cube specimens were made from four batches of concrete with half of the specimens subjected to corrosion.

TABLE 2
Concrete Mix Proportions for Making Specimens

| | Phase I | | | | | Phase II | | | |
|---|---|---|---|---|---|---|---|---|---|
| Ingredient | MN01 | MN02 | MN03 | MN04 | MN05 | MN01 | MN02 | MN03 | MN04 |
| Water Cement Ratio, W/C | 0.52 | 0.52 | 0.52 | 0.52 | 0.52 | 0.52 | 0.52 | 0.52 | 0.52 |
| Quantity, ft³ | 1.4 | 1.4 | 1.4 | 1.4 | 1.4 | 0.69 | 0.69 | 0.69 | 0.69 |
| Cement, lb | 29.3 | 29.3 | 29.3 | 29.3 | 29.3 | 14.4 | 14.4 | 14.4 | 14.4 |
| Fine Aggregate (Sand), lb | 73.0 | 73.0 | 73.0 | 73.0 | 73.0 | 35.8 | 35.8 | 35.8 | 35.8 |
| Coarse Aggregate, lb | 93.5 | 93.5 | 93.5 | 93.5 | 93.5 | 45.9 | 45.9 | 45.9 | 45.9 |
| Water, lb | 15.23 | 15.23 | 15.23 | 15.23 | 15.23 | 7.47 | 7.47 | 7.47 | 7.47 |
| HRWR (Plastol 6400), gm | 33.2 | — | 33.2 | 33.2 | 33.2 | 16.6 | 16.6 | 16.6 | 16.6 |
| Methyl Nicotinate, gm | — | 168.5 | 168.5 | 589.9 | 31.9 | — | 15.6 | 82.7 | 289.3 |
| MN Weight Fraction | 0 | 0.3 | 0.3 | 0.6 | 0.075 | 0 | 0.075 | 0.3 | 0.6 |

The quantity of each batch of concrete in Phase I tests was 1.4 ft³ while the quantity of each batch of concrete for Phase II tests was 0.69 ft³. MN was added to the mixing water before it was mixed with the dry ingredients. This practice provided even dispersion of the corrosion inhibitor. The corresponding MN mass fraction and other batch weight details for these mixes are presented in Table 2. The reference to MN weight fraction in the Table 2 and examples is relative to an internal use of an inhibitor solution including the MN and an initial amount of water. More water was then utilized. The proportion of MN provided to the concrete mixes can be calculated based on ounces of admixture (i.e., MN) per one hundred pounds of cement (oz/cwt).

### Test Details

Table 3. below. lists the tests that were conducted for each phase.

TABLE 3
Tests Conducted

| | Phase I | Phase II | Reference |
|---|---|---|---|
| Wet Concrete Tests: | | | |
| Slump Test | ✓ | | ASTM C143 |
| Unit Weight | ✓ | | ASTM C138 |
| Air Content | ✓ | | ASTM C231 |
| Hardened Concrete Tests: | | | |
| Compressive Strength | ✓ | ✓ | ASTM C39 |
| Corrosion Tests: | | | |
| Corrosion Tests | ✓ | ✓ | Accelerated Test |
| Pull-out Test After Corrosion | ✓ | ✓ | Pull-out Test |

After 28 days of curing, 10 of the specimens from Phase I were subjected to accelerated corrosion, while the remaining 10 were taken out of the curing room and stored in the lab without any treatment. Similarly, those numbers for Phase II were 8 and 8.

### Accelerated Corrosion Tests

In Phase II, a total of 8 concrete specimens were used at the same time for accelerated corrosion testing, with 2 specimens from each concrete batch. To prevent corrosion on the exposed end of the rebar, plastic caps were placed on the bar ends and sealed with a silicon sealant. The specimens were then left to dry in the lab for 24 hours.

To start the corrosion process, each specimen was placed in a plastic container filled with a 5% NaCl solution, which served as an electrolyte. Each specimen was centered inside a 7-inch by 7-inch stainless steel-plated frame, with 3 inches in height, that served as the cathode. The rebar embedded within the cube specimen acted as the anode. Based on Faraday's law, a current of 0.029 A was applied to reach a target corrosion level of 5%. This current was applied using an external power source during the wetting cycle. The entire process lasted for 15 days with a two-day wet cycle followed by one day dry cycle. These exposure cycles were repeated 5 times.

### Pull-out Tests

A universal testing machine with 300-kip capacity was used to determine the pull-out strength of specimens with non-corroded and corroded rebars. A dial gage was attached to the exposed end of the reinforcing rebar within the concrete to measure the slip.

Test Results from Phase 1

### Slump Test Results

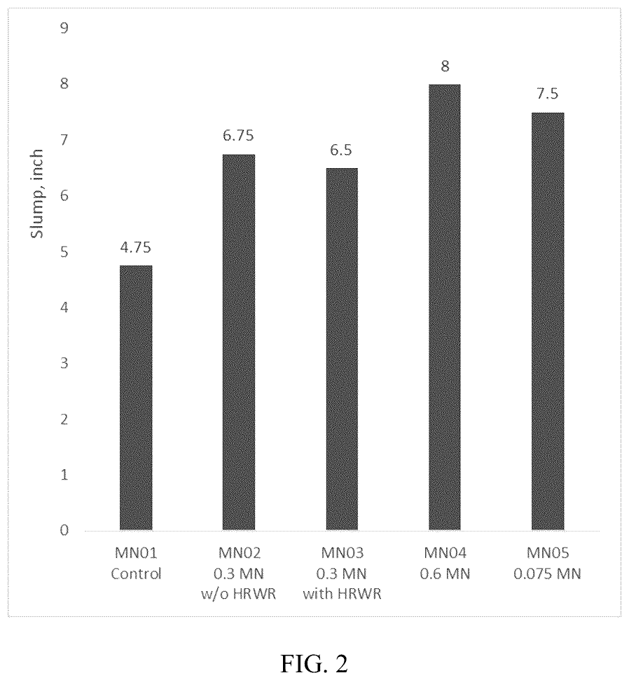

All the mixes showed increased slumps compared to that of the control mix. MN04 with a higher dosage of MN, showed largest slump of 8 inches which is 3.25 inches larger than that of the control mix. The addition of MN increases the slump of concrete making it more workable. These results are shown in FIG. 2.

### Air Content Results

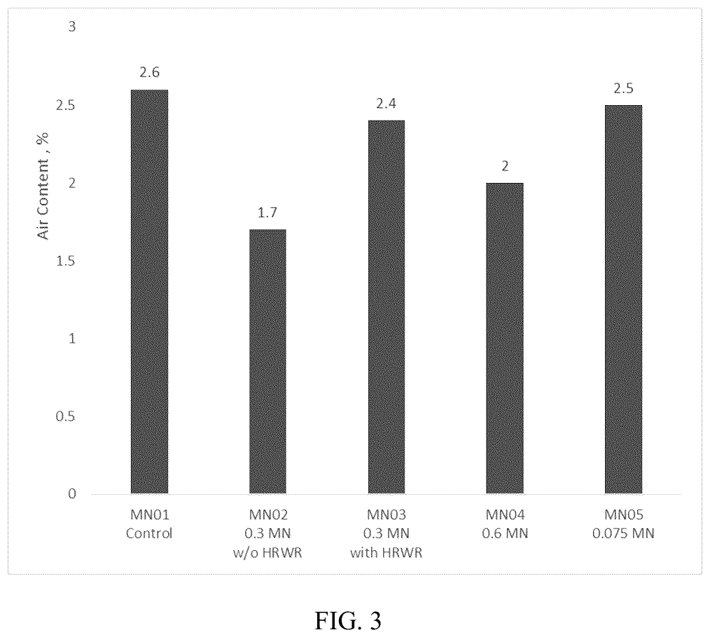

Air content was not significantly influenced by the addition of MN. All mixes showed relatively similar air content values within the normal range of this property for non-air-entrained mixes and any variation was within the expected margin of error. These results are shown in FIG. 3.

### Compressive Strength Test Results

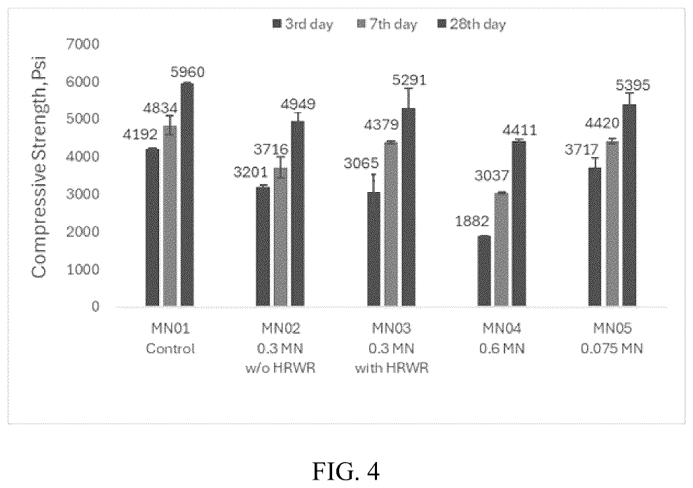

The compressive strength for all concrete mixes were determined after 3, 7, and 28 days. The control mix (MN01) had the highest 28-day strength of 5,960 psi. When MN was added, the strength decreased compared to that of the control mix. MN02 (0.3 weight fraction without HRWR) had a 28-day strength of 4,949 psi which was about 17% lower than that of the control mix. MN03 (0.3 weight fraction with HRWR) had a slightly improved strength of 5,291 psi due to the addition of HRWR. However, it was still about 11% lower than that of the control mix. MN04 (0.6 weight fraction MN) had the lowest strength of 4,411 psi, around 26% lower than that of the control mix. MN05 (0.075 weight fraction MN) performed better than the other MN mixes with a 28-day strength of 5,395 psi, just 9% below that of the control mix because of the smaller dosage of MN. These results are shown in FIG. 4. Overall, increasing the MN dosage tended to reduce the compressive strength but not to an alarming level because the loss of the compressive strength can be compensated and recovered by adding other suitable chemical admixtures to concrete.

Test Details and Results from Phase II
Corrosion Testing with Modified Sealing at the Ends

Phase II tests were conducted to address the limitations observed during Phase I tests. Corrosion test specimens were made with an improved sealing technique to ensure that corrosion occurred primarily within the embedded region of the reinforcing bar. PVC pipe was used as the bond breaker outside of the exposed rebar length extended beyond both ends of the concrete specimens to facilitate effective scaling.

The electrochemical test setup was used for corrosion testing in Phase II as well. Based on Faraday's law, an impressed current of 0.039 A was supplied to produce the target 5% corrosion. In Phase I, a lower current of 0.024 A was used but that was increased to 0.039 A in Phase II to account for the corresponding duration of the wet cycles.

### Pull-out Tests

Pull out tests were conducted for both uncorroded and corroded specimens of all mixes, following the same procedure as in Phase I. Straps were provided to protect the dial gage attached at the bottom from getting damaged in case the concrete specimen failed or fell. Dial gage readings were recorded at regular intervals of 500 lbs. using a dial gage setup. The peak loads were noted at failure for all the specimens.

### Physical Condition of the Corroded Rebar Embedded in the Concrete Specimens

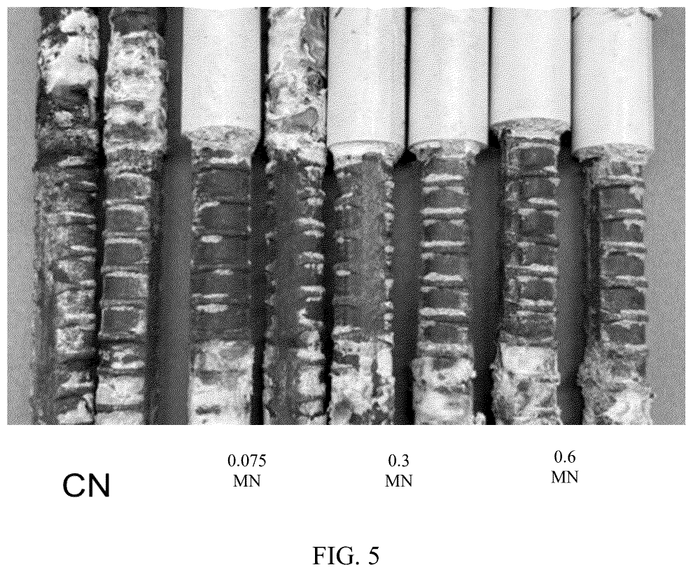

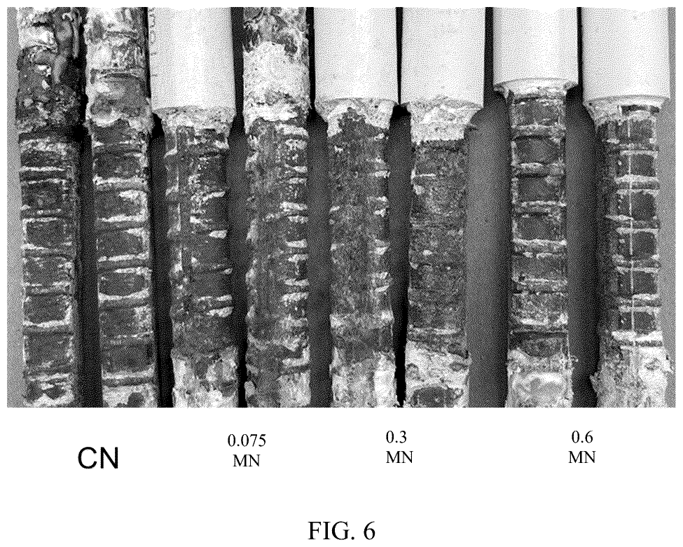

The rebars were removed from the specimens after the peak pullout load was reached to evaluate the surface condition in terms of corrosion over the embedded length. The surface condition showed that the concrete specimens with the highest dosage (0.6 weight fraction) showed no visible signs of corrosion on the rebar. The specimens with lower dosages (0.075 weight fraction and 0.3 weight fraction) exhibited some corrosion but less than that of the control mix (without any MN). The control mix exhibited the highest level of corrosion among all the specimens. This demonstrates that the MN acts as an effective corrosion inhibitor in reinforced concrete. Confirmation of this conclusion will be made with SEM studies of the surface of the rebars extracted from the test specimens. The physical condition of the rebars extracted from the cube specimens is shown in FIG. 5 and FIG. 6.

### Comparison of Pull-out Strength of Uncorroded and Corroded Specimens

The peak pullout loads recorded for specimens with uncorroded and corroded rebars were compared for specimens made from all mix types (MN01 to MN04). Splitting failure of the concrete was observed in many of the corroded specimens prior to the complete pull-out of the rebar from the cube specimens. This suggested that additional confinement would be needed to prevent the specimens from failing in splitting before reaching the peak pull-out load. Prevention of such splitting with additional testing would be expected to show more conclusive results. Voltage and Current Recorded at Different Times During the Accelerated Corrosion Tests

MN01 (Control Mix) specimens were subjected to a consistent target current of 0.039 A for all five wet-dry cycles. Voltage and current were recorded for the corrosion tests. The power supplies struggled to maintain 0.039 A for specimens with higher concentrations of MN. These results suggested that the higher dosage of methyl nicotinate was increasing the resistance for the flow of current and thereby providing the required corrosion resistance.

The targeted current of 0.039 A was successfully maintained for a sample of MN02 up to the second last cycle. However, for another sample of MN02, the voltage demand exceeded the supply limit starting from cycle 3.

For the MN04 mix, high-capacity power supplies were used. A first sample was connected to a power supply with a maximum voltage of 72V, while a second sample was connected to one with a 120V capacity. Despite having higher voltage limits, both specimens were unable to maintain the target current of 0.039 A from the beginning of the test. This suggests that the higher dosage of methyl nicotinate was increasing the resistance for the flow of current and thereby providing the required corrosion resistance. These test results are encouraging for the ability of methyl nicotinate to serve as a corrosion inhibitor.

Various modifications and alterations that do not depart from the scope and spirit of this invention will become apparent to those skilled in the art. This invention is not to be duly limited to the illustrative embodiments set forth herein.

What is claimed is:

1. A concrete composition comprising binder, aggregate, and a corrosion inhibitor, the corrosion inhibitor comprising an alkoxy group, a carboxyl group, and a nitrogen-containing aromatic group.

2. The concrete composition of claim 1, where the carboxyl group of the corrosion inhibitor connects the alkoxy group and the nitrogen-containing aromatic group.

3. The concrete composition of claim 1, where the corrosion inhibitor is a methyl ester.

4. The concrete composition of claim 1, where the corrosion inhibitor is methyl nicotinate.

5. The concrete composition of claim 1, where the corrosion inhibitor has a molecular weight less than 150 g/mol.

6. The concrete composition of claim 1, where the corrosion inhibitor has an energy gap value of less than 6.5 eV.

7. The concrete composition of claim 1, where the concrete composition includes from about 1 ounce of the corrosion inhibitor per 100 pounds of the binder (oz/cwt) to 80 oz/cwt.

8. The concrete composition of claim 1, where the alkoxy group is a methoxy group or an ethoxy group.

9. The concrete composition of claim 1, where the nitrogen-containing aromatic group is a pyridine group or a pyrrole group.

10. The concrete composition of claim 1, where the concrete composition is reinforced with reinforcing bars.

11. The concrete composition of claim 10, where the reinforcing bars are made of carbon steel.

12. The concrete composition of claim 1, where the corrosion inhibitor has a molecular weight between 115 and 150 g/mol.

13. The concrete composition of claim 1, where the corrosion inhibitor has an energy gap value between 3.5 eV and 6.5 eV.

14. The concrete composition of claim 1, where the concrete composition is in a state of becoming a final concrete material, the concrete composition further comprising water to be hydrated with the binder.

15. The concrete composition of claim 1, where the concrete composition is a final concrete material.

16. The concrete composition of claim 1, further comprising a high range water reducer.

17. The concrete composition of claim 1, further comprising an additive for increasing compressive strength.

18. The concrete composition of claim 1, where the concrete composition includes from about 10 ounces of the corrosion inhibitor per 100 pounds of the binder (oz/cwt) to 20 oz/cwt.
